(19) United States
(12) Patent Application Publication
(10) Pub. No.: US 2014/0281322 A1
(43) Pub. Date: Sep. 18, 2014

(54) Temporal Hierarchical Tiered Data Storage

(71) Applicant: Silicon Graphics International Corp., Milpitas, CA (US)

(72) Inventor: Charles Robert Martin, Superior, CO (US)

(73) Assignee: Silicon Graphics International Corp., Milpitas, CA (US)

(21) Appl. No.: 13/831,702

(22) Filed: Mar. 15, 2013

(51) Int. Cl. G06F 3/06

(52) U.S. Cl. CPC G06F 3/0611; G06F 3/0647; G06F 3/0683
USPC 711/165

(57) ABSTRACT

Embodiments of the invention includes identifying the priority of data sets based on how frequently they are accessed by data center compute resources or by other measures assigning latency metrics to data storage resources accessible by the data center, moving data sets with the highest priority metrics to data storage resources with the fastest latency metrics, and moving data sets with lower priority metrics to slower data storage resources with slower latency metrics. The invention also may be compatible with or enable new forms of related applications and methods for managing the data center.

### BACKGROUND OF THE INVENTION

1. Field of the Invention

The present invention generally relates to a data storage system. More specifically, the present invention relates to providing data storage for data associated with a temporal distance.

2. Description of the Related Art

The modern data center contains a plurality of heterogeneous types of data storage equipment wherein data is stored in what are referred to as “tiers”. Each tier is conventionally referred to by number, such as tier 0, tier 1, tier 2, and tier 3, with lower number tiers usually referring to more expensive and relatively fast data storage media and locations offering lower latency data access to the data processing computer resources, while higher number tiers are typically less expensive but higher-latency data storage. In prior art data centers, tier 0 typically consists of random access memory, tier 1 consists of solid state disks, tier 2 consists of fast disk drives, and tier 3 consists of slower disk drives or tape.

Conventionally, higher priority data sets are data sets that are accessed more frequently, they are typically stored on faster more costly data storage devices to improve performance and response times: tier 0 or 1 for example. Conversely, data sets that are accessed less often are typically moved to data storage devices of slower speeds associated with higher numbered tiers to reduce costs.

Significant variations in latency can also be observed when comparing the latency of particular data storage devices or subsystems within a given tier. One reason for this variation is that the data center contains data storage equipment from different data storage vendors. The data storage equipment uses various types of communication interfaces and different types of storage devices that are located within the same tier. This is one reason why some data storage devices located within a tier are faster than other data storage devices. In some instances, the performance of a particular data storage device or subsystem may vary over time. Thus, legacy hierarchical data storage architectures that move data between tiers do not truly optimize the location of a data set to the priority of that data set to a fine degree.

Tiers in legacy hierarchical data storage architectures therefore only provide coarse associations of priority versus access time to data or latency. They do not optimize data center performance optimally. Legacy hierarchical data storage architectures thus are “leaving money on the table” by not optimally associating the value (priority) of data sets with the speed of data storage resources on which particular data sets are stored. What is needed are improvements to increase data center efficiency.

### SUMMARY OF THE CLAIMED INVENTION

The invention described herein optimizes storage of particular data sets by associating data set priority to data storage resource latency metrics collected by data center compute resources. An embodiment of the invention identifies the priority of data sets based on how frequently they are accessed by data center compute resources, or by other measures. The invention then assigns latency metrics to data storage resources accessible by the data center and moves data sets with the highest priority metrics to data storage resources with the fastest latency metrics. Data sets with lower priority metrics may be moved to slower data storage resources with slower latency metrics. Some embodiments of the invention also allow users to manually assign priority metrics to individual data sets or to groups of data sets associated with data processing projects or tasks. The invention increases the performance of the data center by optimally associating the priority of data sets with the speed of data storage resources on which particular data sets are stored.

The invention also may be compatible with or enable new forms of related applications and methods for managing the data center. A first such method relates to managing data sets that temporarily store data sets in underutilized data storage resources located outside of the physical data center until there is sufficient time to migrate lower priority data to long-term data storage. A second such method relates to triggering preventative maintenance of specific data storage resources when the performance of a data storage resource changes significantly.

### BRIEF DESCRIPTION OF THE DRAWINGS

FIG. 1 illustrates a data center and computers external to the data center

FIG. 2 illustrates a simplified block diagram of a data center compute resource.

FIG. 3 is a flow diagram illustrating program flow in an embodiment of the invention.

FIG. 4 illustrates a flowchart of a method for enabling new forms of related applications for managing the data center.

FIG. 5 illustrates an exemplary computing system 500 that may be used to implement a computing device for use with the present technology.

### DETAILED DESCRIPTION

The invention described herein optimizes where particular data sets are stored by associating data set priority to data storage resource latency metrics collected by data center compute resources. Embodiments of the invention correlate the priority of data sets and the latency of data storage resources to a finer degree of resolution than possible when using conventional tiered hierarchical data storage management. This is possible because conventional legacy hierarchical data storage management only associates data set priority to data storage tier. Such “legacy” approaches do not account for variations in latency within a tier that commonly occur in the data centers of the prior art. In contrast with legacy approaches, the temporal hierarchical data storage architecture relies on a plurality of different latency metrics that are related to access time measurements made by data center compute resources.

In this disclosure data storage resources that have the smallest latency will be referred to as being located “closer” to the compute resources that consume, manipulate, or characterize data, and data storage resources that have the larger latencies will be referred to as being “farther” from the data center's compute resources. Thus the terms “closer” or “farther” relate to temporal distance. Data that is less frequently accessed is migrated to “slower” data storage resources that are “farther” from the data center's compute resources, and vice-versa; data that is more frequently accessed in migrated to “faster” data storage resources that are “closer” to the data center's compute resources. As discussed above, current hierarchical data storage management architectures do not truly match any given data set to data storage resources optimally because tiers in legacy hierarchical data storage management architectures have no true measure for latency of discrete data storage resources contained within a tier.

FIG. 1 illustrates a data center and computers external to the data center. FIG. 1 depicts a Data Center 101 with a plurality of internal elements including a plurality of Compute Resources 102, a plurality of solid state drives (SSDs) 103, a plurality of slower disk drives 104, a plurality of tape drives 105, Network Adaptors 106, and a wireless network antenna 107. Wired network cables 108 connect the Data Center's 101 Network Adaptors 106 to a plurality of Desktop Computers 109 that are outside of the Data Center 101, Notebook Computers with wireless network antennas 110 are also depicted outside of the Data Center 101.

FIG. 1 also includes controller 120 and application 122. Controller may be implemented as one or more computing devices that communicate and control movement of data among compute resources 102, SSD drives 103, disk drives 104, and tape drives 105. Application 122 may be implemented as one or more modules stored in memory of the controller and executed by one or more processors to implement the present invention and move data among compute resources 102, SSD drives 103, disk drives 104, and tape drives 105. For example, application 122 may be executed to perform the methods of FIGS. 3-4, discussed in more detail below.

FIG. 2 illustrates a simplified block diagram of a data center compute resource. The data center compute resource 201 of FIG. 2 includes Microcomputer 202 in communication with Random Access Memory 203, a Solid State Disk 204, and a Local Area Network 205. Such computer resources are standard in the art, they sometimes are referred to a compute nodes. Essentially they are high speed computers that include some memory and a communication pathway to communicate with other resources in the data center, including other data center compute or data storage resources.

FIG. 3 is a flow diagram illustrating program flow in an embodiment of the invention. First, latency metrics are assigned to data storage resources that are discretely referenced by data center compute resources at step 301. Priorities of data sets utilized by data center compute resources may be identified at step 302. The priorities of individual data sets may be associated to discretely referenced data storage resources at step 303. After which, individual data sets may be migrated to the data storage resources that the individual data sets have been associated with at step 304. The system then measures latencies to at least a first portion of data from the discretely referenced data center resources at step 305 After some time, the method of FIG. 3 continues back to step 301 where latency metrics are assigned to data storage resources that are discretely referenced by data center compute resources again.

The method depicted in FIG. 3 thus is capable of updating associations of data set priority to measured latencies to discretely referenced data storage resources over time. This enables the data center to re-optimize the placement of data sets: if a particular data set's priority changes or if a particular data storage resource slows down, data sets will be moved to an appropriate data storage resource, optimizing the value of the data center. Note: latency metrics may be assigned to data storage resources that are located inside the data center 201 or outside of the data center in devices that include yet are not limited to desktop computers 209, or notebook computers 210.

The latency of discrete data storage resources are typically measured by an initiator of a data request such as a data center compute node. Latency metrics will typically correspond to the access time from when a data request is initiated to when at least a first portion of data is received by the initiator of the data request. Certain embodiments of the invention, however may assign latency metrics that correspond to the access time from when a data request is initiated to when at a particular number of bytes of data has been received by the initiator of the data request.

A first example embodiment of the invention could therefore generate latency metrics based on the temporal distance to the first bits of data received from a data storage resource, and a second example embodiment of the invention could generate latency metrics based on the temporal distance to a first particular number of bytes. The first example is a measure of initial latency, and the second example is a measure of initial latency and sustained transfer speed of particular data storage resource.

The method of the invention thus can intelligently evaluate the health of discretely referenced data storage resources or trigger preventive maintenance on a particular data storage device. For example if a particular disk drive slows down un-expectantly, perhaps it needs to be defragmented: or perhaps if the performance of a solid state drive reduces significantly, perhaps it should be replaced.

Certain embodiments of the invention optimize the temporal distance where data sets are located based on the priority of the data sets. Furthermore, the priority of the data sets typically corresponds to how frequently those data sets are accessed by data center compute resources, and higher priority data sets typically are associated with having a greater value to the data center.

Embodiments of the invention may contain any number of “latency metrics” for a given class of data storage resource. For example a data center may contain 100 raid arrays. Certain embodiments of the invention could associate 10 different latency metrics with those 100 raid arrays, where other embodiments of the invention could associate 100 different latency metrics to those 100 raid arrays.

The data storage resources do not necessarily correspond to particular physical data storage devices or subsystems, however. The invention is also capable of assigning latency metrics to abstracted data storage device resources that exist in the data center. For example, Drive H may be a partition or portion of a physical disk drive. In such an instance, Drive H may be assigned one “latency metric” while other partitions of the same physical device may be assigned a different “latency metric”. Thus even though the location of where a data storage device physically exists is abstracted from the data center's compute resources it may be assigned “latency metrics” based on how it is identified or addressed by the data center compute resources.

The invention thus increases the performance of the data center by optimally associating the value (priority) of data sets with the speed of data storage resources on which particular data sets are stored.

Certain other embodiments of the invention are compatible with or enable new methods of managing data center data outside of the physical boundaries of the conventional data center. For example, lower priority data sets targeted for storage on tape or other slow long-term data storage resources may be migrated through data storage resources that are located outside of the data center, on desktop, notebook, or other computing devices. Another example includes a method that triggers preventative maintenance of specific data storage resources when the performance of a data storage resource changes significantly.

FIG. 4 illustrates a flowchart of a method for enabling new forms of related applications for managing the data center. FIG. 4 is meant to illustrate examples of how the invention could be configured to interact with or enable new forms of data center methods and systems, it is not an exhaustive review of the limitations of such methods or systems that the invention may interact with or enable.

First, a determination is made as to whether a data set is assigned to long-term data storage at step 401. If the data is assigned to long-term data storage, the method continues to step 402. If the data is not assigned, the method continues to step 405.

A determination is made at step 402 if long-term data storage bandwidth may be constrained. If bandwidth may be constrained, a call is made to external data migration utility at step 404. If bandwidth is not constrained, data sets are migrated to associated data storage resources already associated with the particular data sets at step 403.

Returning to step 405, latency history may be imported for a referenced data storage resource. A determination is then made as to whether the performance of a particular discretely referenced data storage resource collapsed at step 406. If the performance has not collapsed at step 406, the method of FIG. 4 continues to step 403. If the performance has collapsed, a preventative maintenance ticket is opened at step 407.

FIG. 5 illustrates an exemplary computing system 500 that may be used to implement a computing device for use with the present technology. System 500 of FIG. 5 may be implemented in the contexts of the likes of controller 120. The computing system 500 of FIG. 5 includes one or more processors 510 and memory 520. Main memory 520 stores, in part, instructions and data for execution by processor 510. Main memory 520 can store the executable code when in operation. The system 500 of FIG. 5 further includes a mass storage device 530, portable storage medium drive(s) 540, output devices 550, user input devices 560, a graphics display 570, and peripheral devices 580.

The components shown in FIG. 5 are depicted as being connected via a single bus 590. However, the components may be connected through one or more data transport means. For example, processor unit 510 and main memory 520 may be connected via a local microprocessor bus, and the mass storage device 530, peripheral device(s) 580, portable storage device 540, and display system 570 may be connected via one or more input/output (I/O) buses.

Mass storage device 530, which may be implemented with a magnetic disk drive or an optical disk drive, is a non-volatile storage device for storing data and instructions for use by processor unit 510. Mass storage device 530 can store the system software for implementing embodiments of the present invention for purposes of loading that software into main memory 520.

Portable storage device 540 operates in conjunction with a portable non-volatile storage medium, such as a floppy disk, compact disk or Digital video disc, to input and output data and code to and from the computer system 500 of FIG. 5. The system software for implementing embodiments of the present invention may be stored on such a portable medium and input to the computer system 500 via the portable storage device 540.

Input devices 560 provide a portion of a user interface. Input devices 560 may include an alpha-numeric keypad, such as a keyboard, for inputting alpha-numeric and other information, or a pointing device, such as a mouse, a trackball, stylus, or cursor direction keys. Additionally, the system 500 as shown in FIG. 5 includes output devices 550. Examples of suitable output devices include speakers, printers, network interfaces, and monitors.

Display system 570 may include a liquid crystal display (LCD) or other suitable display device. Display system 570 receives textual and graphical information, and processes the information for output to the display device.

Peripherals 580 may include any type of computer support device to add additional functionality to the computer system. For example, peripheral device(s) 580 may include a modem or a router.

The components contained in the computer system 500 of FIG. 5 are those typically found in computer systems that may be suitable for use with embodiments of the present invention and are intended to represent a broad category of such computer components that are well known in the art. Thus, the computer system 500 of FIG. 5 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims

What is claimed is:

1. A method for optimizing the temporal distance of one or more data sets stored on one or more data storage resources comprising:
identifying the priority of the one or more data sets;
assigning a latency metric to each of the one or more data storage resources wherein at least a first data storage resource has a faster latency metric than at least one other data storage resource; and
associating the priority of the one or more data sets to the one or more data storage resources wherein a first data set with a higher priority is targeted to be moved to the first data storage resource with the faster latency metric, and wherein at least one other data set is targeted to be moved to the at least one other data storage resource with the latency metric slower than the first data set latency metric.

2. The method of claim 1 further comprising:
moving the first data set with higher priority to the first data storage resource; and
moving the at least one other data set with lower priority to the at least one other data storage resource.

3. The method of claim 2 further comprising:
a plurality of data sets each with an associated priority;
a plurality of data storage resources each assigned a latency metric; and
moving the plurality of data sets to the plurality of data storage resources wherein data sets with higher priorities are moved to data storage resources with faster latency metrics, and wherein data sets with lower priorities are moved to data storage resources with slower latency metrics.

4. The method of claim 3 further comprising measuring latencies of the plurality of data storage resources over time.

5. The method of claim 3 further comprising:
re-assigning latency metrics to the plurality of data storage resources;
re-associating the priority of the plurality of data sets to the plurality of data storage resources; and
moving the plurality of data sets to the plurality of data storage resources wherein data sets with higher priorities are moved to data storage resources with faster latency metrics, and wherein data sets with lower priorities are moved to data storage resources with slower latency metrics.

6. The method of claim 3 further comprising:
identifying data sets targeted for long-term data storage and calling a data migration utility configured to temporally move the data sets targeted for long-term data storage on data storage resources contained within computers that are located outside of the physical boundaries of the data center.

7. The method of claim 4 further comprising:
identifying data storage resources with latencies or latency metrics that have collapsed over time; and
opening a preventative maintenance ticket identifying the data storage resources with latency metrics that have collapsed over time.

8. A system for optimizing the temporal distance of one or more data sets stored on one or more data storage resources comprising:
a processor;
a memory;
one or more modules stored in memory and executable by a processor to:
identify the priority of the one or more data sets;
assign a latency metric to the one or more data storage resources wherein at least a first data storage resource has a faster latency metric than at least one other data storage resource; and
associate the priority of the one or more data sets to the one or more data storage resources wherein a first data set with a higher priority is targeted to be moved to the first data storage resource with the faster latency metric, and wherein at least one other data set is targeted to be moved to at least one other data storage resource with a latency metric slower than the first data set latency metric.

9. The system of claim 8 further comprising:
moving the first data set with higher priority to the first data storage resource; and
moving the at least one other data set with lower priority to the at least one other data storage resource.

10. The system of claim 9 further comprising:
a plurality of data sets each with an associated priority;
a plurality of data storage resources each assigned a latency metric; and
moving the plurality of data sets to the plurality of data storage resources wherein data sets with higher priorities are moved to data storage resources with faster latency metrics, and wherein data sets with lower priorities are moved to data storage resources with slower latency metrics.

11. The system of claim 10 further comprising measuring latency of the plurality of data storage resources over time.

12. The system of claim 10 further comprising:
reassigning latency metrics to the plurality of data storage resources;
re-associating the priority of the plurality of data sets to the plurality of data storage resources; and
moving the plurality of data sets to the plurality of data storage resources wherein data sets with higher priorities are moved to data storage resources with faster latency metrics, and wherein data sets with lower priorities are moved to data storage resources with slower latency metrics.

13. The system of claim 10 further comprising:
identifying data storage resources data sets targeted for long-term data storage and calling a data migration utility configured to temporally move the data sets targeted for long-term data storage on data storage resources contained within computers that are located outside of the physical boundaries of the data center.

14. The system of claim 11 further comprising:
identifying data storage resources with latency metrics that have collapsed over time; and
opening a preventative maintenance ticket identifying the data storage resources with latency metrics that have collapsed over time.
